(19) United States
(12) Patent Application Publication
(10) Pub. No.: US 2010/0264807 A1
(43) Pub. Date: Oct. 21, 2010

(54) LAMP WITH IR SUPPRESSING PHOTONIC LATTICE

(75) Inventor: Deeder AURONGZEB, Mayfield Heights, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/425,024

(22) Filed: Apr. 16, 2009

(51) Int. Cl. H01J 1/00; H01J 9/04

(52) U.S. Cl. 313/326; 445/48

(57) ABSTRACT

A light emitting device that includes a radiation emitter. The radiation emitter includes an emissive substrate which emits radiation. The device further includes an attenuating layer formed by annealing a layer of a different material with the substrate. An array of light transmission channels which are sized to suppress infrared radiation during operation of the light emitting device, extend into the attenuating layer.

### BACKGROUND OF THE DISCLOSURE

The exemplary embodiment relates to infrared suppression in an incandescent lamp. It finds particular application with regard to lamps comprising an attenuator, such as a photonic lattice, for suppressing emission of infrared radiation from the lamp's emitter while increasing the efficiency of a lamp, and will be described with particular reference thereto.

Conventional incandescent lamps, while providing high quality, inexpensive lighting, are extremely inefficient. Resistively or non-resistively heated light sources, including incandescent and discharge lamps, generally emit a majority of the emitted radiation in the infrared region of the spectrum. Approximately five to ten percent of the energy supplied to a filament is converted into electromagnetic radiation at wavelengths within the visible region of the spectrum, i.e., about 400 nm to about 700 nm. A large amount of energy is converted to radiation in the infrared region of the spectrum, i.e., between about 700 nm to about 3000 nm, and wasted as heat. Because this energy remains in the lamp envelope, tungsten, which has a very high melting point, greater than 3200° C., has historically been employed for use as a filament and electrode material.

With the invention of thin film technology, lamp efficiency has increased due to the application of ultraviolet and infrared reflective coatings being applied to the filament and/or electrode to direct at least a portion of the discharge back to the filament. While this technology has been able to reduce energy losses with about a 30% efficiency rate, it nonetheless does not address the issue of suppression or conversion of unwanted light emissions.

U.S. Pat. No. 5,079,437, to Waymouth, discloses a means of suppressing unwanted wavelength emissions. This involves the use of a radiating device having microcavities with a cavity diameter suitable for suppressing 700 nm and above wavelengths. U.S. Pat. No. 7,368,870 to Wang discloses radiation emitting structures which include an active radiation emitter surrounded by a passive photonic crystal structure that is transparent to wavelengths of electromagnetic radiation within the visible region of the electromagnetic spectrum. U.S. Publication No. 2008/0024061 to Bunk, et al., discloses an incandescent lamp having a carbide containing luminous element which uses a wire for the luminous element that is coated on the outside with at least two different high melting metal compounds from at least one of the groups of carbides, borides, and nitrides. U.S. Publication No. 2008/0152943 to Aurongzeb discloses a process for the creation of a photonic lattice on the surface of an emissive substrate. U.S. Ser. No. 11/946,273 to Cseh, et al., discloses a lamp with an optical grating for increasing efficiency and reducing the emission of infrared radiation from the lamp.

The foregoing, while advancing the technology to some degree, there remains a significant quantity of energy that is emitted as electromagnetic radiation outside the visible region of the spectrum. The energy wasted contributes to the inefficiency of conventional incandescent lamps. Thus there remains a need for a lamp which selectively attenuates infrared radiation while providing desirable illumination and energy efficiency.

### BRIEF DESCRIPTION OF THE DISCLOSURE

One aspect of the exemplary embodiment relates to a light emitting device that includes a radiation emitter. The radiation emitter includes an emissive substrate which emits radiation. The device further includes an attenuating layer formed by annealing a layer of a different material with the substrate. An array of light transmission channels which are sized to suppress infrared radiation during operation of the light emitting device, extend into the attenuating layer.

Another aspect of the exemplary embodiment relates to a method of forming a light emitting device that includes depositing a layer on one surface of an emissive substrate. The method further includes annealing the layer and the substrate to form an attenuating layer. The attenuating layer is in the form of a single crystal or a large grain. The method further includes forming an array of light transmission channels into the attenuating layer. The channels are sized to suppress infrared radiation at an operating temperature of the light emitting device.

Another aspect of the exemplary embodiment relates to a light emitting device that includes a glass bulb with fill gas. A radiation emitter is sealed within the bulb and includes first and second layers and different material compositions. The first layer includes a material which emits light when heated. The second layer includes a composite material which includes a metal, boron, nitrogen, and carbon. The device further includes an array of channels formed in the second layer and an electrical conductor connected with the first layer for connecting the first layer with a power source.

One advantage of at least one embodiment of the present disclosure is the provision of a lamp with improved performance and luminous efficiency.

Another advantage of at least one embodiment is the provision of a light emitter with improved high temperature stability.

Still further advantages will become apparent to those of ordinary skill in the art upon reading and understanding the following detailed description of the preferred embodiments.

### BRIEF DESCRIPTION OF THE DRAWINGS

FIG. 1 is a perspective view of an incandescent lamp in accordance with one aspect of the exemplary embodiment;

FIG. 2 is an enlarged perspective view of the attenuator and emitter in the form of a ribbon coil of the lamp of FIG. 1 showing in greatly enlarged cross-sectional view a portion thereof;

FIG. 3 is a three dimensional perspective view of a substrate and attenuator of the lamp of FIG. 1 in accordance with one aspect of the exemplary embodiment;

FIG. 4 is an enlarged cross-sectional view of a substrate and attenuator lattice showing channels of different shapes;

FIG. 5 is a top perspective view of the attenuator of FIG. 3; and

FIG. 6 is a theoretical plot of emissivity of a filament comprising the exemplary light emitter of FIG. 3.

### DETAILED DESCRIPTION OF THE PREFERRED EMBODIMENTS

Aspects of the exemplary embodiment relate to a radiator emitter for use in lamps capable of generating a wavelength shift, or suppression of emissions, where the suppressed wavelength is emitted in the form of visible light, thus increasing lamp efficiency. Lamp energy, which has heretofore been lost at a rate of up to about 70% in the form of UV and IR emissions, is more efficiently utilized as visible light. Rather than being merely reflected, the lamp IR and optionally also UV emissions are suppressed and refocused for emission in the visible range. In the description below, the lamp is described in terms of an incandescent halogen lamp, although it is to be appreciated that other lamp types are also contemplated.

The exemplary lamp finds application in a variety of applications including household lighting, projection lamps, and illumination in stores and other commercial applications.

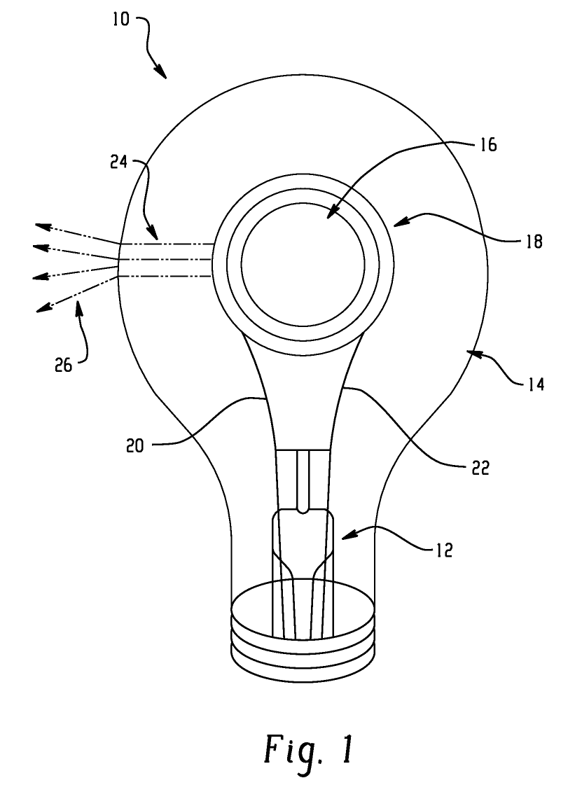

With reference to FIG. 1, one embodiment of an exemplary halogen incandescent lamp is shown. The lamp includes a bulb 10 which is hermetically sealed, for example, by a seal 12 at one or both ends, to define an interior chamber 14. While FIG. 1 shows a single ended lamp bulb, double ended lamp bulbs are also contemplated. The illustrated bulb 10 is spherical, although it is to be appreciated that the bulb may be elliptical, cylindrical, or other suitable lamp shape. The bulb 10 is formed of a material which is light transmissive, i.e., transmissive to radiation in the visible range and may also be transmissive in the IR range. Suitable materials for forming the bulb include transparent materials, such as quartz glass, and other vitreous materials, although translucent materials, such as ceramic materials, are also contemplated. In one embodiment, the bulb is formed of aluminosilicate glass or quartz doped with Zr and/or Ta in an amount of at least 0.1% by weight, such as 5% Zr and 2% Ta.

The lamp includes a radiation emitter 16. In the illustrated embodiment, the emitter 16 emits radiation in at least the visible range and generally also the IR range of the spectrum where an electric current is applied thereto. The illustrated emitter 16 includes at least one current conducting member, here illustrated as a ribbon coil 18, which is disposed within the interior chamber 14. Rather than a ribbon coil, other radiation emitters are contemplated, such as a filament wire, filament coil, electrode, or the like. The ribbon coil 18 is connected with an exterior source of electrical power, e.g., via an electronic circuit comprising a ballast (not shown). In the illustrated embodiment, the connection is made via electrically conducting connectors 20, 22, such as wires, passing through the seal 12. Exemplary ribbon coil 18 extends generally traverse to the horizontal axis in the lamp bulb and, during operation of the lamp, emits radiation, illustrated by rays 24, in substantially all directions. At least a portion of the radiation is emitted from the lamp in the form of visible light, illustrated by rays 26.

The chamber 14 may be filled with a fill gas, such as an inert gas, e.g., a mixture of helium and nitrogen (such as 500 torr helium and 100 torr nitrogen) or a halogen-containing fill. In other embodiments, the fill may include an inert gas, such as nitrogen, helium, and/or argon, and an additive in an amount of at least 1% by weight. The additive may be least one of dimethyl amino tantalum (Ta(N(CH₃)₂)₅ and BX, where X represents a halogen selected from F, Cl, X, and combinations thereof. As an example, the fill may comprise nitrogen (e.g., at 40-95 wt %, e.g., about 90 wt %) argon (e.g., at 2-20 wt %, e.g., about 5 wt %), at least 2% dimethyl amino tantalum (e.g., about 4%), and optionally at least 1 wt % BX (e.g., about 2%). Another example fill may include 50 wt % nitrogen, 40 wt % helium, 5 wt % dimethyl amino tantalum and 5% BX. A color temperature of the lamp may be, for example, >2900 K, and in one embodiment, less than <3500 K.

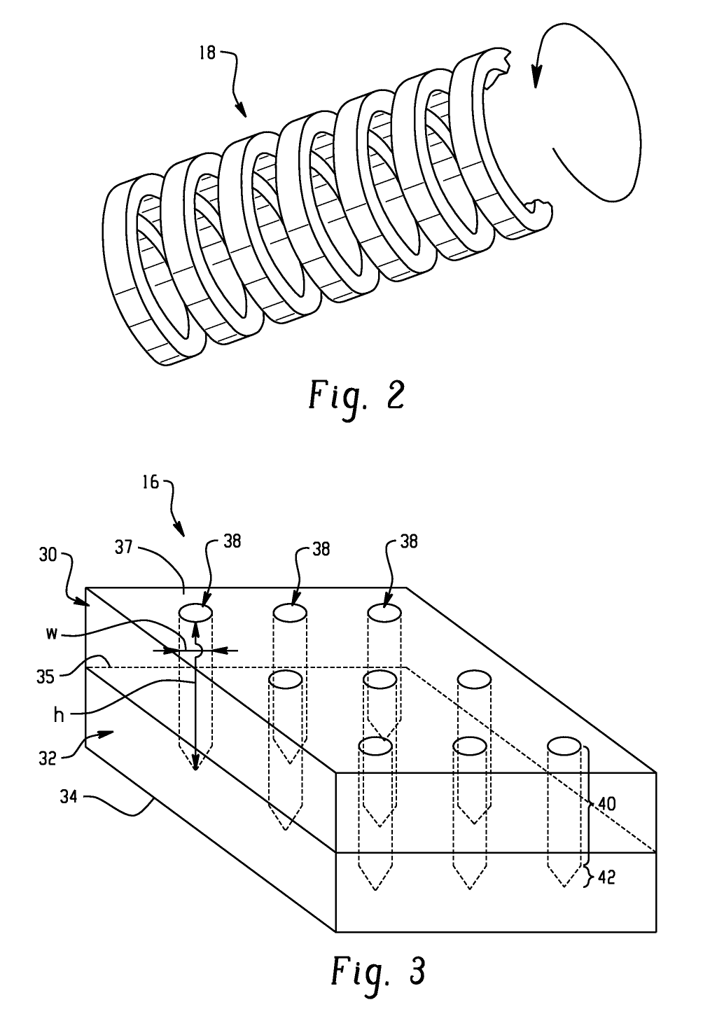

With reference to FIG. 2, illustrated is an enlarged perspective view of a portion of the exemplary ribbon coil 18 shown in FIG. 1.

As shown in FIG. 3, the radiation emitter 16 includes an attenuator 30 which is supported on an emissive substrate 32. The substrate 32 is planar having opposed planar first and second surfaces 34, 35. Flatness is the degree to which is approximates a mathematical plane. The root mean square roughness of the planar surfaces may be at least 0.2 μm, and generally less than about 150 μm. e.g. about 20 μm. The exemplary attenuator 30 is in the form of a photonic lattice. The photonic lattice may be in the form of an annealed layer 36 contiguous with the surface 35 of the emissive substrate 32. In one embodiment, opposed sides 34, 35 of the emissive substrate 32 may support a layer 36. The layer 36 may be in the form of a single crystal or large grains and have a surface 37, generally parallel with and spaced from surface 35. The layer 36 defines array of light transmission channels 38, each sized to suppress the emission and/or suppress the transmission of infrared radiation from the emissive substrate 32 at a normal operating temperature of the lamp (e.g., from 2700K-3300K) to improve overall efficiency of the lamp. The array may be regular, as shown, with the channels 38 approximately equally spaced. In other embodiments, the array may be irregular.

The channels 38 extend partially or completely through the layer 36 from upper surface 37 to surface 35 and optionally into the underlying substrate 32. The channels 38 each have a proximal portion 40 within the attenuator layer 36 and a distal portion 42 within substrate layer 32. The channels 38 may be configured to have a cylindrical wall 44 in portion 40 which tapers inward in portion 42, e.g. to a point. While cylindrical portions 40 are illustrated in FIG. 3, the channels 38 may have a shaped selected from conical, pyramidal, cylindrical, rectangular prism, and combinations thereof. The exact shape may be a function of the technique used to create the channels 38.

The channels 38 may have an approximate width w in layer 36 which is less than about 500 μm, e.g., about 100-400 μm, and in one embodiment, at least about 200 μm, such as about 300 μm. The width w of the proximal portion 40 may be greater than a width of the distal portion 42. The channels 38 may have an approximate height h along an axis of the channel which is less than about 1000 nm (1 μm), e.g., about 200-800 nm, and in one embodiment, at least about 400 nm, such as about 600 nm. Width w is measured at ½ h.

The layer 36 may have a thickness t of at least about 1 μm, and generally less than about 500 nm, e.g., about 100 nm. The substrate 32 may have a thickness s of at least 2 μm, and generally less than about 750 μm, e.g. 400 μm. The thickness of the substrate can be less than a width W of the substrate.

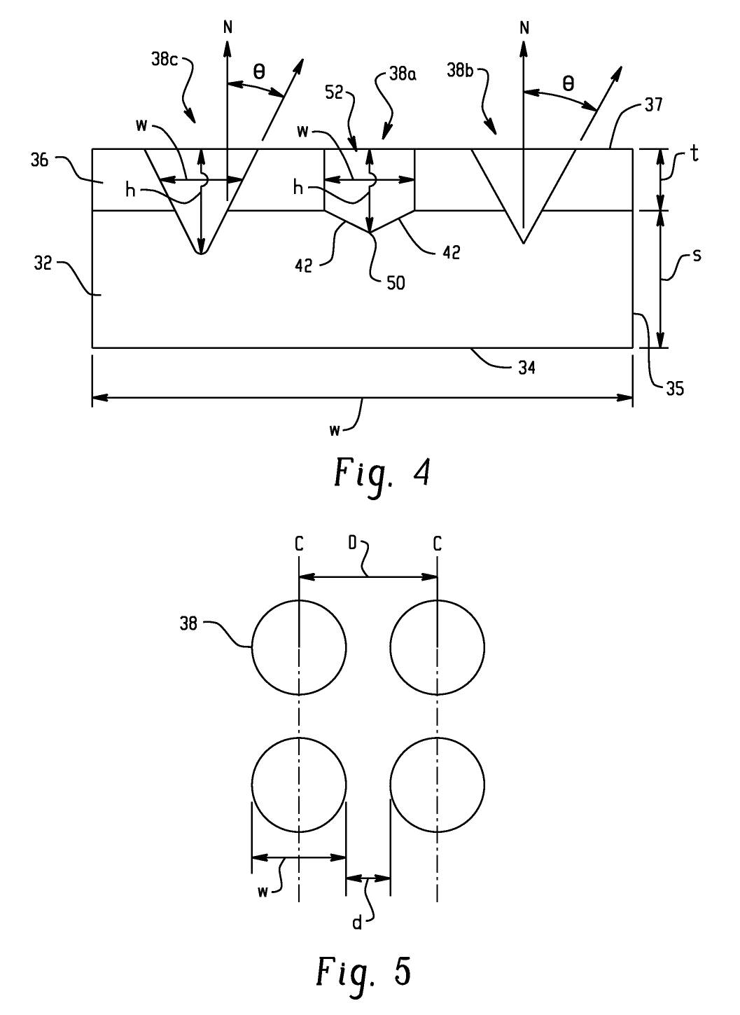

FIG. 4 shows three different embodiments of a channel 38a, 38b, and 38c. Channel 38a is as shown in FIG. 3, i.e. with a proximal portion 40 where the wall is of uniform cross-section and a distal portion 42 which is of decreasing cross-section, tapering to point 50. The height h of the channel exceeds the thickness t of the layer 36. For example, h≧1.1t, e. g., h≧1.2t. In the channel 38b, the walls taper in both portions 40 and 42. In the channel 38c, the wall tapers in both portions 40, 42, but not to a point. With respect to FIG. 4, the tilt of the channel walls may be measured as ≦±20° (Θ) from normal (N). In one embodiment, h/w>1+sin Θ. The penetration of the channels 38a, b, and c into layer 32 leads to an increase in stability of the structure.

FIG. 5 shows a top view of the surface 37 of the layer 36 of FIG. 3. The distance D between two adjacent channels centers (c) may be at least 400 nm, and generally less than about 900 nm, e.g. about 500 nm. In one embodiment, the radius (½ r) of the holes is greater than the distance d between them. In another embodiment, where adjacent channels are designed to emit in the red region of the spectrum, e.g. 550 nm to 1.2 μm, D and r may be large in order to operate in the visible range. For a broad range of luminous intensity, a portion, e.g., 60% of the adjacent channel centers are 500 nm apart, and another portion, e.g., 40% are 1000 nm (1 μm) apart to yield uniform light distribution. In another embodiment, the channels may each have a diameter (2r) at the surface of the attenuator layer which varies by no more than 20%. In another embodiment, the distance D between centers of the channels at a surface of the attenuator layer varies by no more than 20% over the array.

With regard to the pairing of substrate 32 and layer 36 materials suitable for use in the radiation emitter 16, the substrate 32 may exhibit a melting point higher than that of the layer 36. The substrate 32 may be a metal or metal compound. Exemplary materials include tungsten, osmium, rhenium, tantalum, the oxides thereof, the nitrides thereof, and the carbides thereof, and combinations thereof. The difference in melting point of layers 32 and 36, with that of the substrate 32 being higher than that of the layer 36, reduces the possibility of interface diffusion occurring. Interface diffusion may compromise the structural integrity of the substrate and thus its performance. The metal, metal compound, or combination thereof, such as tungsten, may be present in layer 32 in at least 10% pure, by weight. e.g., at least 40% by weight, at least 90% by weight. For example, layer 32 can be predominantly formed of tungsten, e.g., up to 99.999% by weight tungsten, except for at an interface with the layer 36, where diffusion of material during the annealing of layer 36 to the substrate 32 may result in a lower tungsten concentration. In another embodiment, the substrate is formed of TaC.

The layer 36 may include a metal and/or a metal compound selected from high melting point metals and carbonitrides, such as TaCN, TaB_{w}CₓN_{y}, ZrₓHf_{y}Ta_{z}CN, C and W, and combinations thereof, wherein w=<0.5, x=>0.5, y=1−x and z=<1. In the case of W, this is generally present in a weight percent that is less than in the substrate, and may be derived from the substrate 32 during annealing. The metal and/or metal compound, such as TaC or TaCN, may be present in layer 36 in at least 10%, by weight, e.g., at least 40% by weight, or at least 90% by weight. For example, layer 32 can be up to 99.9999% by weight TaCN (except for in a diffusion layer at the surface of the substrate formed during annealing). In an embodiment, the layer 36 includes a boron compound. The boron may be in the alpha phase and be partially ionic. A suitable composite, comprises a refractory metal, such as Ta, in combination with B, C, and N, such as TaB_{w}CₓN_{y}, may be employed as layer 36 as it is adaptable to high temperature stress. In this embodiment, carbon may be less than 30 wt % of the layer, and in one embodiment, less than 20 wt %.

The channels 38 may include a dielectric or semicondutive fill material 52 to help maintain structural integrity for the channel walls. The fill material 52 may be selected from Y, Hf, Zr, Ta, Ti, B, Th, Be, the oxides thereof, borides thereof, carbides thereof, and combinations thereof. The fill materials, may be present singly or in combination in at least 10% by weight, e.g., at least 40% by weight, or at least 90% by weight of the fill material, and can be up to 99.999% by weight. For example, the dielectric fill material may include a boride in combination with a carbide. The boride/carbide combination may be present in at least 10% by weight, e.g., at least 40% by weight, or at least 60% by weight of the fill material, and can be up to 99.999% by weight. In this embodiment oxygen may be less than about <1% by weight of the fill material 52.

In one embodiment, wherein the layer 36 is predominately formed of a metal or metal compound containing boride or nitride, the dielectric fill material 52 may include an oxide. In another embodiment, wherein the layer 36 is predominately formed of a metal or metal compound containing a carbide or carbonitride, the dielectric fill material 52 may include a boride.

The exemplary emissive substrate 32 and the layer 36 defining the photonic lattice form a ribbon coil 18 having first and second surfaces 34, 37. The first and second surfaces are generally parallel.

A method of forming the light-emitting device includes depositing or otherwise forming a contiguous layer 36 on the emissive substrate 32. Suitable depositing techniques include chemical vapor deposition (CVD) and ion beam deposition. The layer 36 may have a thickness t of at least about 1 μm, and generally less than about 500 nm, e.g., about 100 nm. The substrate 32 may have a thickness s of at least 2 μm and generally less than about 750 μm, e.g. 400 μm. The thickness of the substrate can be less than a width W of the substrate. The substrate 32 may be roughened prior to the layer 36 being deposited on the surface 35 of the substrate 32, e.g., by plasma etching or argon ion bombardment. The root mean square (rms) roughness may be equal to twenty percent (20%) of the thickness t of the layer 36. The rms roughness may be at least 0.2 μm, and generally less than about 150 μm, e.g., about 20 μm. The surface etching has the effect of reducing substrate/film stresses which may otherwise occur as the material is heated in use. Since the substrate 32 is planar, a layer 36 may be deposited on both sides of the substrate 32, which may or may not be of the same composition.

The method further includes the layer 36 and the substrate 32 being annealed to create a single crystal layer 36 or large grains (diameter>twice the width w, e.g. >1-4 μm) on the substrate 32 surface. To produce the single crystal layer 36 or large grains, the layer 36 may undergo rapid thermal annealing in the presence of the substrate 32 for at least 12 hours and up to about 24 hours at a temperature of at least 1000° C. to up to about 2000° C. or higher. For example, 5 hours at 2500° C. may be sufficient for annealing a layer 36 of BN on a substrate of TaCN. Longer times, e.g., >12 hours, may be appropriate for tungsten substrates. The annealing time may depend on the thickness of the layer 36 and the melting point of the material of layer 36 which may be at least 2500° C. to up to about 3000° C. (i.e., higher than the annealing temperature). The annealing temperature is selected to be below the melting point of the material in layers 32, 35, but high enough to create a strong bond between the two layers 32, 26, optionally by diffusion of one material into the other. The initial structure of layer 36 may be a grain structure having a grain size of <200 nm, or less than the distance between the two adjacent channels. The annealed structure of layer 36 and substrate 32 may be a grain structure having a grain size >500 nm and <3 μm.

Once the annealing step of the process has been completed, the layer 36 and substrate 32 are channeled by electron beam bombardment or plasma etching to form channels 38. By moving an ion beam in a circle, channels may be formed as for 38b and 38c. For 38a, the angle of the beam is approximately zero. For channels 38b, 38c, the beam is angled. The etching method disclosed herein results in channel walls having roughened surfaces. This is advantageous for creating the largest surface area possible, which results in more efficient suppression of undesirable wavelength emissions. The optimized surface energy is formed when height (h)/width (w)>1+sin Θ. The channels may then be filled with a dielectric material such as Y, Hf, Zr, Ta, Ti, B, Th, Be, oxides thereof, borides thereof, carbides thereof, and combinations thereof which is light transmissive.

The method further includes spirally winding the emissive substrate 32 and the layer 36 with photonic lattice therein into a plurality of concentratic superposed turns to form a ribbon coil having first and second surfaces, wherein the first and second surfaces are generally parallel. The exemplary ribbon coil reduces in size fitting into a space of about 2.5 cm.

To form an incandescent lamp, the radiation emitter 16 is inserted into a bulb and the bulb filled with a halogen fill and/or inert gas and sealed. The emitter is connected to conductors which are sealed in the bulb. The substrate and the attenuator may form a ribbon coil.

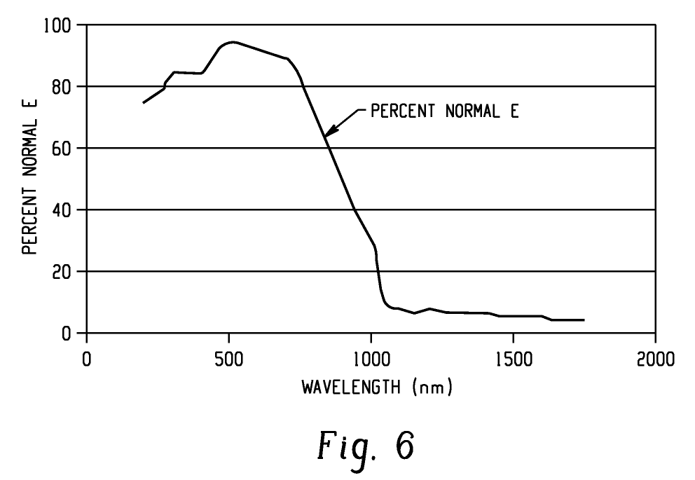

FIG. 6 is a theoretical plot of emissivity for a single crystal layer when using a ribbon coil bearing the photonic lattice of the exemplary embodiment for a lattice in which the spacing D is 500 nm. One function of the photonic lattice is to suppress infrared emissions above about 900 nm, while transmitting in the visible range, which is illustrated in FIG. 6.

While the exemplary lamp is described in terms of an incandescent lamp, it is to be appreciated that the exemplary photonic lattice may find application in other lamps which emit radiation in the IR range, such as ceramic metal halide lamps, halogen incandescent lamps, and the like.

Without intending to limit the scope of the exemplary embodiment, the following example illustrates the formation of the light emitting device.

### EXAMPLE

A layer 36 of BN was deposited using ion beam deposition onto a planar substrate 32 of TaC. The layer and substrate were annealed for 5 hours at 2500° C. forming a layer 36 of TaBCN wherein carbon was <20% by weight of TaBCN and B is generally in the alpha phase (e.g., >60%). The substrate TaC provided the initial stable film for BN growth. After annealing, the composite structure of the layer 36 and substrate 32 had a grain size <200 nm which was less than the diameter of the channel and distance between the channel. The channels were then formed using a focused ion beam at 40 kev, according to the shape 38a shown in FIG. 4.

The invention has been described with reference to the preferred embodiments. Obviously, modifications and alterations will occur to others upon reading and understanding the preceding detailed description. It is intended that the invention be construed as including all such modifications and alterations.

1. A light emitting device comprising:
a radiation emitter comprising:
an emissive substrate, which emits radiation;
an attenuating layer formed by annealing a layer of a different material with the substrate; and
an array of light transmission channels which are sized to suppress infrared radiation during operation of the light emitting device, the channels extending into the attenuating layer.

2. The device of claim 1, wherein the emissive substrate is planar.

3. The device of claim 1, wherein the layer of a different material is in the form of a single crystal or large grains.

4. The device of claim 1, further comprising a second attenuating layer formed by annealing a layer of a different material with an opposed surface of the substrate.

5. The device of claim 1, wherein the substrate comprises at least one of a metal and a metal compound selected from the group consisting of tungsten, tantalum, nitrides thereof, carbides thereof, and combinations thereof.

6. The device of claim 1, wherein the attenuating layer comprises at least one of a metal compound and a metal selected from the group consisting of TaCN, TaB_{w}C_{z}N_{y}, ZrₓHf_{y}Ta_{z}CN, C and W, and combinations thereof, and
wherein w=<0.5, x=>0.5, y=1−x, and z=<1.

7. The device of claim 1, wherein the attenuating layer comprises at least 10 wt. % boron in an alpha phase.

8. The device of claim 1, wherein the channels extend through the attenuating layer into the substrate.

9. The device of claim 1, wherein the channels have a shape selected from the group consisting of conical, pyramidal, cylindrical, rectangular and combinations thereof.

10. The device of claim 1, further including a dielectric fill material in the channels.

11. The device of claim 10, wherein the fill material is selected from the group consisting of yttrium, hafnium, zirconium, tantalum, titanium, boron, thorium, beryllium, oxides thereof, borides thereof, carbides thereof, and combinations thereof.

12. The device of claim 1, wherein the radiation emitter is in the form a ribbon coil having first and second surfaces, wherein the first and second surfaces are generally parallel.

13. The light emitting device of claim 1, further comprising:
a bulb, and
wherein the radiation emitter is sealed within the bulb; and
conductors extending into the bulb to connect the emitter with a source of power.

14. The light emitting device of claim 1, wherein the channels each have a diameter at a surface of the attenuator layer which varies by no more than 20%.

15. The light emitting device of claim 1, wherein a distance between centers of the channels at a surface of the attenuator layer varies by no more than 20%.

16. A method of forming a light emitting device comprising:
depositing a layer on at least one surface of an emissive substrate;
annealing the layer and the substrate to form an attenuating layer, the attenuating layer is in the form of a single crystal or a large grain; and
forming an array of light transmitting channels which extend into the attenuating layer the channels being sized to suppress infrared radiation at an operating temperature of the light emitting device.

17. The method of claim 16, further includes roughening the surface of the emissive substrate prior to depositing the layer on the surface.

18. The method of claim 17, wherein the roughening is performed by at least one of plasma etching and argon ion bombardment.

19. The method of claim 16, wherein depositing the layer on the substrate includes at least one of least chemical vapor deposition and ion beam deposition.

20. The method of claim 16, wherein forming the channels includes at least one of electron beam bombardment and plasma etching.

21. The method of claim 16, wherein the channels extend completely through the attenuating layer and into the substrate.

22. The method of claim 16, wherein the channels have a shape selected from the group consisting of conical, pyramidal, cylindrical, rectangular and combinations thereof.

23. The method of claim 16, further including depositing a dielectric fill material within the channels

24. The method of claim 16, further including spirally winding the emissive substrate and the attenuator layer into a plurality of concentratic superposed turns to form a ribbon coil having first and second surfaces, wherein the first and second surfaces are generally parallel.

25. A light emitting device comprising:
a bulb;
a radiation emitter sealed within the bulb and comprising first and second layers and different material compositions, the first layer comprising a material which emits light when heated, the second layer comprising a composite material which includes a metal, boron, nitrogen, and carbon; and
an array of channels formed in the second layer;
an electrical conductor connected with the first layer for connecting the first layer with a power source.
